(19) United States
(12) Patent Application Publication
(10) Pub. No.: US 2009/0289868 A1
(43) Pub. Date: Nov. 26, 2009

(54) GROUND PLANE

(75) Inventor: Robin GRANGER, Winchester (GB)

Correspondence Address: CROWELL & MORING LLP;INTELLECTUAL PROPERTY GROUP, P.O. BOX 14300, WASHINGTON, DC, 20044-4300, US

(73) Assignee: Roke Manor Research Limited, Romsey (GB)

(21) Appl. No.: 12/333,905

(22) Filed: Dec. 12, 2008

(30) Foreign Application Priority Data
May 20, 2008 (GB) 0809117.5

(51) Int. Cl. H01Q 1/48

(52) U.S. Cl. 343/848

(57) ABSTRACT

A ground plane for an antenna comprises first and second planar conductors (102, 103) arranged substantially perpendicular to a central axis of the antenna joined together and spaced from one another by a third conductor (104) arranged substantially concentric with and parallel to the central axis. An edge of the first planar conductor (102) is radially outward of an edge of the second planar conductor (103), and the second planar conductor extends radially outwardly from the third conductor (104) a distance of substantially one sixth of a wavelength of an operating frequency of the antenna.

This invention relates to a ground plane, in particular for antennas for satellite communication systems, such as global navigation satellite system (GNSS) antennas.

As well as single or dual frequency antennas, there are multi-GNSS antennas, e.g. suitable for reception of global positioning system (GPS), Russian global navigation satellite system (GLONASS) and European Space Agency Galileo signals. Reducing the sensitivity of a multi-GNSS antenna to electromagnetic radiation (radio waves) incident upon the antenna from below the horizon (e.g. particularly to multipath signals reflected from the ground immediately beneath the antenna) is not simply a matter of using the same techniques as apply to single or dual frequency antennas.

Wanted signals in satellite communications are received at an antenna from above the horizon, but the ground also produces unwanted reflections, arriving at the antenna from below the horizon, which usually need to be minimised or eliminated. Such unwanted signals can, for example in the case of a precision ‘geodetic’ GNSS antenna, cause significant errors in the position solution calculated by a receiver. Although a simple ground plane sheet will prevent signals from beneath being transmitted to the antenna, it is not possible to make the sheet infinitely wide so, at the edge of the sheet, the unwanted signal is diffracted and can reach the antenna.

As previous GNSS antennas have mostly been single frequency or dual-frequency, the problem has been solved by the use of a ‘choke ring ground plane’ which normally works over only a very narrow frequency range, typically of the order of 10 MHz or so. These conventional designs of ground plane employ ‘choke rings’: a series of concentric cylindrical conducting walls, approximately one-quarter of a wavelength tall attached to the ground plane. The effect is to produce a high-impedance surface across which GNSS signals (including the multipath) cannot propagate, but the effect is limited in bandwidth to just one or two GNSS frequencies for which the choke rings are adapted. The choke rings may have a slight taper effect by varying their heights from the edge to the centre, in order to increase their effective bandwidth, or may be of the same height. They are most often oriented vertically, perpendicular to a horizontal ground plane, but some examples, such as in U.S. Pat. N. 6,940,457, use horizontal disc-like choke rings attached to a vertical, cylindrical ground plane. An alternative type of ground plane suitable for broadband use employs lossy (resistive) materials to absorb the unwanted radio energy. An example of this that has been proposed, as described in U.S. Pat. No. 5,694,136, is the use of a ground plane coated in lossy material which has increasing sheet resistivity the further it is from the centre where the antenna is situated. The effect is to ‘soften’ the edge of the groundplane, thus reducing the diffraction around it, by presenting a much more gradual change in impedance. However, this method requires special materials, or manufacturing techniques.

In accordance with the present invention, a ground plane for an antenna comprises first and second planar conductors arranged substantially perpendicular to a central axis of the antenna joined together and spaced from one another by a third conductor arranged substantially concentric with and parallel to the central axis; wherein an edge of the first planar conductor is radially outward of an edge of the second planar conductor, and wherein the second planar conductor extends radially outwardly from the third conductor a distance of substantially one sixth of a wavelength of an operating frequency of the antenna.

The present invention provides a ground plane for antennas which is able to operate across a broader spectrum, rather than just at one or two specific frequencies.

Preferably, the planar conductors are spaced by a distance substantially one fifth of a wavelength of the operating frequency of the antenna.

The first and second planar conductors are generally of a similar shape, but different size. They could be elliptical, but preferably, the first and second planar conductors are radially symmetric about the central axis: circular discs are most suitable, but any higher order regular polygon with radial symmetry may be used.

Preferably, the first conductor comprises a material having a substantially constant sheet resistivity.

For ease of manufacture and keeping down costs, the first conductor may be made of metal. Alternatively, the first conductor is made of a material with a constant sheet resistivity in the range of about 300 to 400 ohms per square; and preferably of the order of 350 ohms per square. This gives better performance, but may be more complex and costly to manufacture than using a metal.

Preferably, the third conductor comprises a hollow cylinder.

The type of cylinder, e.g. right circular, elliptic, or higher order polygon, is generally related to the shape of the first and second planar conductors themselves.

Preferably, an end plate is provided at an end of the cylinder remote from the antenna.

This prevents stray signals from reaching the antenna from below and may be integral with, or separate from the antenna housing. The shape of the end plate is generally adapted to the shape of the cylinder.

Preferably, an antenna is mounted coaxially within the cylinder.

Preferably, the antenna is spaced from the walls of the cylinder.

In order to accommodate the antenna, preferably, the second planar conductor comprises an annular disc.

Preferably, the antenna comprises a spiral antenna.

The spiral antenna may be mounted within the cylinder in the same plane as the annular disc.

Alternatively, the second planar conductor comprises a solid plate.

Preferably, a patch antenna is mounted on the solid plate.

An example of a ground plane in accordance with the present invention will now be described with reference to the accompanying drawings in which:

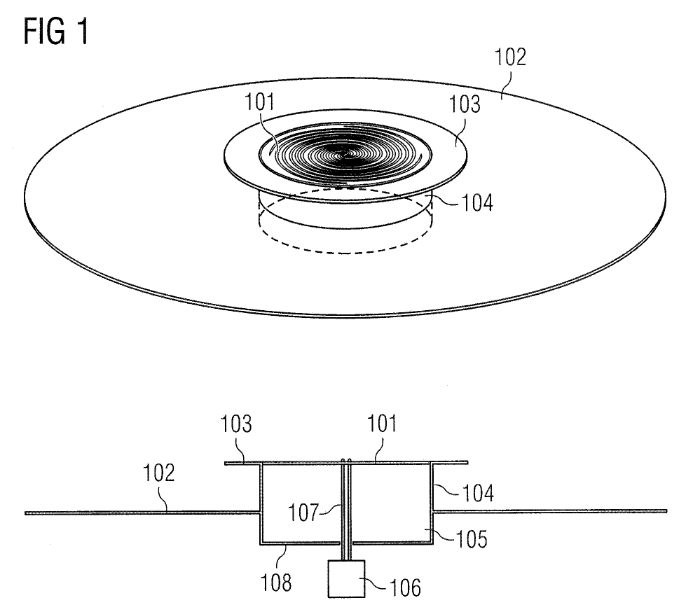

FIG. 1 illustrates a first example of a ground plane according to the present invention, with an integrated spiral antenna;

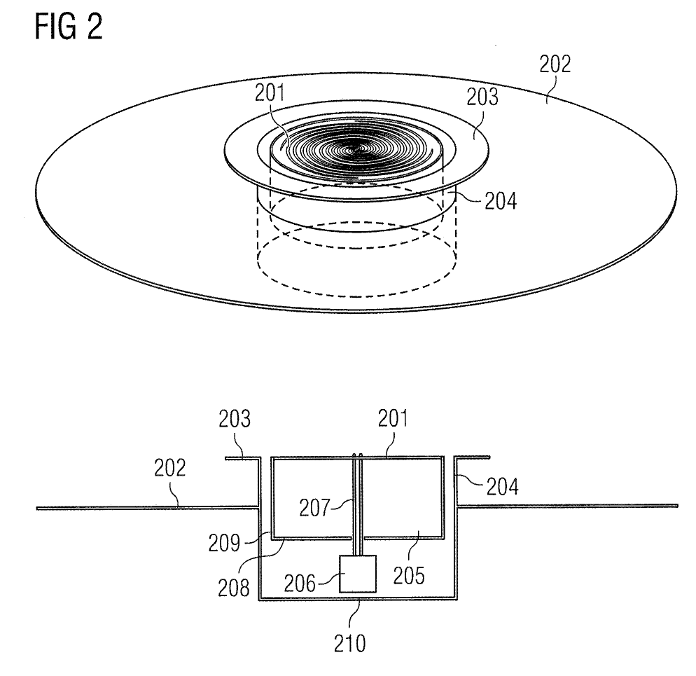

FIG. 2 illustrates a second example of a ground plane according to the present invention, for a free standing spiral antenna; and,

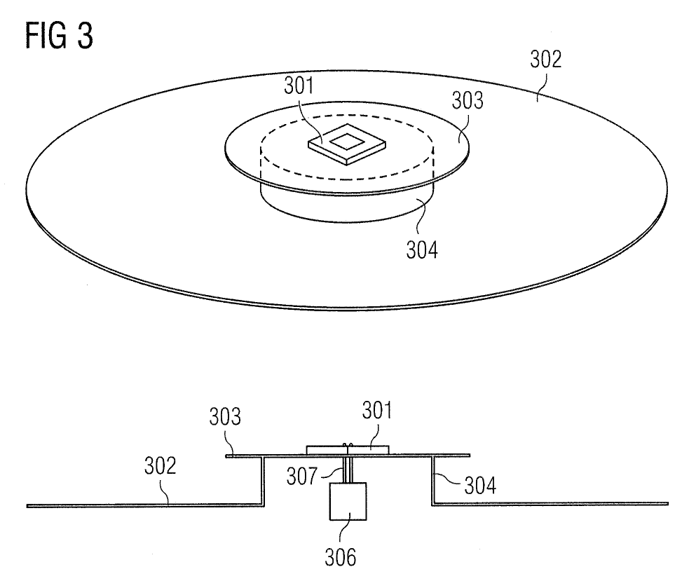

FIG. 3 illustrates a third example of a ground plane according to the present invention, for a patch antenna.

The present invention provides a conducting or partly-conducting structure which can be adapted to fit any GNSS antenna in order to reduce the effects of satellite signals reflected from the ground or a surface immediately below the antenna. GNSS antennas typically operate at frequencies ranging from approximately 1100 MHz to 1300 MHz (e.g. GPS and GLONASS L2, Galileo E5ab and E6) and approximately 1550 MHz to 1610 MHz (e.g. GPS and GLONASS L1, Galileo E2-L1-E1). As described above, it is usual to have to adapt the ground plane to the frequency of the antenna, so multi-frequency capable antennas are not adequately protected by conventional ground planes.

The design of the present invention performs well across a much wider bandwidth, offering multipath rejection at all of the most common GNSS frequencies, making it suitable for multi-GNSS receiver applications where high phase precision is required, e.g. ground reference stations. Whilst the basic design is entirely conducting (e.g. made from metal), the use of lossy or resistive materials for the lower groundplane has been shown to improve performance further at the cost of increased manufacturing complexity and antenna noise figure. The best improvement in performance is for materials with a sheet resistivity of the order of 300 to 400 ohms per square.

The ground plane of the present invention comprises a first wide flat conducting member, or sheet to be positioned in a plane below the plane of the antenna. Multipath signals (originating from below the antenna) are diffracted at the edge of the ground plane and propagate along the upper surface of the first conducting sheet towards the antenna. Close to the antenna, spaced approximately one fifth of a wavelength from the first sheet of the ground plane is a second flat conducting member. The two flat conducting members are joined by a vertical conducting member which forms a short circuit between the two conductors. The diffracted component of the wave becomes constrained between the parallel surfaces of the two conducting sheets and terminated by the short-circuit at the end of the waveguide so formed, then reflected back along the surface of the first sheet of the ground plane away from the antenna. A small amount of diffraction may occur on the edge of the upper conducting sheet, but its effect is not significant. The antenna is fitted in such a way that it has substantially complete shielding from beneath, either by means of part of the conducting sheets, or from the antenna construction itself. For example a patch antenna may be mounted on top of the upper conducting sheet, which is continuous, whereas a cylindrical cavity-backed antenna (e.g. spiral) might have the upper sheet fitted around it in the form of a ring or annulus.

Antennas for GNSS applications typically work in the frequency range 1100 to 1600 MHz where the free-space wavelength is correspondingly between 273 mm and 186 mm. In one embodiment of the invention, this gives rise to a lower groundplane which is 515 mm in diameter, an upper disc which is 215 mm diameter and spaced 40 mm above the lower groundplane, and a central supporting cylinder which is 140 mm diameter.

The shape formed by the conducting cylinder and upper disc when placed onto a simple ground plane, gives a ‘shorted waveguide effect’ that results in the response being substantially independent of frequency, and is therefore suitable for antennas which must operate over broad frequency ranges.

FIG. 1 illustrates a first example of the present invention in which a flat conductive disc 102 effectively shields a cavity-backed spiral antenna 101 from signals arriving from below, except for a small proportion of the signals which are diffracted around the edge of the disc. The diffracted component is allowed to propagate across the disc towards the antenna 101. However, a second, smaller conductive disc 103 comes into play and confines the wave from above in a form of parallel-plate waveguide. A conductive cylinder 104 essentially forms a short-circuit to this waveguide. This results in a complete reflection of the wave back to where it originated, instead of allowing it to reach the antenna 101. In this example, the second conductive disc 103 takes the form of an annular ring and is fitted in the same plane as, but external to, the antenna 101. The spiral antenna, ring, cylinder and flat conductive disc are all radially symmetric. The second conductor extends radially in a plurality of directions from a central axis. The spiral antenna is fed from the associated circuitry 106 through wires 107 which pass through a cavity 105 formed by the cylinder 104 and end plate 108.

FIG. 2 illustrates a modified example of the ground plane of FIG. 1 in which the antenna is mounted on a housing 209 which is independent of the cylinder 204. As before, a first planar conductor 202 and second planar conductor 203 are coupled by the cylinder 204. The cylinder has a base plate 210 to close the cylinder off at the bottom. The antenna 201 is spaced from the walls of the cylinder 204.

FIG. 3 shows a third example of a ground plane according to the present invention. In this example, first and second planar conductors 302, 303 and a cylinder 304 form the ground plane. A patch antenna 301 is mounted on the second planar conductor 303, which in this case is formed as a continuous solid disc. The feed lines 307 and associated circuitry 306 are beneath the disc.

In all of these examples, the planar conductors are illustrated by circular discs, or rings. For high-precision antennas (i.e. those requiring low phase centre variation), radial symmetry is particularly important. However, any radially symmetric shape can be used, so the circular disc and right circular cylinder can be replaced by a hexagon, octagon, or other higher order polygon.

1. A ground plane for an antenna, the ground plane comprising first and second planar conductors arranged substantially perpendicular to a central axis of the antenna joined together and spaced from one another by a third conductor arranged substantially concentric with and parallel to the central axis; wherein an edge of the first planar conductor is radially outward of an edge of the second planar conductor, and wherein the second planar conductor extends radially outwardly from the third conductor a distance of substantially one sixth of a wavelength of an operating frequency of the antenna.

2. A ground plane according to claim 1, wherein the planar conductors are spaced by a distance substantially one fifth of a wavelength of the operating frequency of the antenna.

3. A ground plane according to claim 1, wherein the first and second planar conductors are radially symmetric about the central axis.

4. A ground plane according to claim 1, wherein the first conductor comprises a material having a substantially constant sheet resistivity.

5. A ground plane according to claim 1, wherein the third conductor comprises a hollow cylinder.

6. A ground plane according to claim 5, wherein an end plate is provided at an end of the cylinder remote from the antenna.

7. A ground plane according to claim 5, wherein an antenna is mounted coaxially within the cylinder.

8. A ground plane according to claim 7, wherein the antenna is spaced from the walls of the cylinder.

9. A ground plane according to claim 1, wherein the second planar conductor comprises an annular disc.

10. A ground plane according to claim 1, wherein the antenna comprises a spiral antenna.

11. A ground plane according to claim 1, wherein the second planar conductor comprises a solid plate.

12. A ground plane according to claim 11, wherein a patch antenna is mounted on the solid plate.
